(19) United States
(12) Patent Application Publication
(10) Pub. No.: US 2025/0211386 A1
(43) Pub. Date: Jun. 26, 2025

(54) DEVICE, SYSTEM, AND METHOD TO REDUCE RADIO FREQUENCY SELF-INTERFERENCE IN SIMULCAST RADIO SYSTEMS

(71) Applicant: MOTOROLA SOLUTIONS, INC., Chicago, IL (US)

(72) Inventors: David P. GURNEY, Carpentersville, IL (US); Pawel ABRAMCZUK, Krakow (PL); Sanjaykumar S. KARPOOR, Buffalo Grove, IL (US)

(21) Appl. No.: 18/393,083

(22) Filed: Dec. 21, 2023

(51) Int. Cl. H04L 5/00; H04W 72/0453

(52) U.S. Cl. CPC H04L 5/0048; H04W 72/0453

(57) ABSTRACT

A base station or a controller generates a first random variable according to a given distribution. The base station or the controller maps the first random variable to a second variable using a bimodal distribution of offset values. The base station uses the second variable to offset a given respective frequency of transmitted symbols.

### BACKGROUND

In some radio systems, two or more base stations broadcast the same symbols at a same time on a same radio frequency to increase chances of radios in the system successfully receiving the signal. Such systems may be referred to as simulcast systems and/or simulcast radio systems and may be implemented with digital mobile radios and/or land mobile radios, and the like, operated by first responders, utility users or commercial enterprise users. However, the RF signals broadcast by the two or more base stations may reach a radio out of phase, so that the RF signals that carry the same symbols interfere with each other. Indeed, signals as little as 10 to 20 degrees out of phase may cause significant signal degradation. Such interference may hence cause symbols to be lost, and, when a user operating the radio is responding to an incident, such loss of symbols (e.g., which may be referred to as sync or data errors) may cause critical information (e.g., such as voice data) encoded in the symbols to be lost.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a simulcast radio system to reduce radio frequency self-interference, in accordance with some examples.

FIG. 2 is a device diagram showing a device structure of a computing device to reduce radio frequency self-interference in simulcast radio systems, in accordance with some examples.

FIG. 3 is a flowchart of a method to reduce radio frequency self-interference in simulcast radio systems, in accordance with some examples.

FIG. 4 depicts the system of FIG. 1, implementing aspects of a method to reduce radio frequency self-interference in simulcast radio systems, in accordance with some examples.

FIG. 5 depicts bit error rate and sync loss as a function of time at a communication device with, and without, the method of FIG. 3 being implemented, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Simulcast radio systems (e.g., hereafter referred to as a simulcast system for simplicity) include base stations that broadcast symbols on a same frequency in a time-coordinated manner, on which information, such as voice or data, may be encoded. Such simulcast systems may be implemented for use by radios of first responders (e.g., police officers, fire fighters, emergency medical technicians, security guards and/or other private first responders, and the like), utility users, industrial users, and/or commercial/enterprise users to ensure that such information reaches the radios. While such simulcasting may provide a transmit diversity effect for radios to improve overall system coverage and reliability, simulcast signals may result in destructive self-interference due to out of phase radio frequency (RF) signals arriving at the receiver (e.g., subscriber, mobile or portable unit). This form of interference has similarities to multipath distortion observed in the field for other communications systems (e.g., where the radio signal that carries symbols take different paths to reach a radio). Such destructive interference may occur when two or more simulcast signals are similar in signal strength, and approach 180 degrees out of phase relative to each other, which may result in lengthy signal/voice or data drop-outs. Such drop-outs may occur when the signals are within as little as 10 to 20 degrees of being 180 degrees out of phase at the receiver.

Regardless, such destructive interference may result in higher radio receiver bit error rate (BER) and/or lost signal packets (e.g., lost voice or data packets) and/or sync loss in the receiver, and the like. Furthermore, increased differential delay among signals arriving at a radio may increase a range of phase angle differences between received signals that may further result in even higher radio receiver BER and/or more lost signal packets and/or more sync loss, and the like.

While times at which same symbols are broadcast at different base stations may be adjusted or staggered, and the like, to minimize differential delays at the receiver, coordinating such broadcast times may be challenging, and may not effectively address problems in all signal reception areas. While traditional dithering techniques (e.g., such as adding random Gaussian phase noise to signals) may be used to reduce the effects of destructive interference, such techniques are often not applicable for frequency modulators (e.g., using frequency-shift keying (FSK) or continuous four level frequency modulation (C4FM)) since the transmitted signal phase is not readily available or accessible (e.g., in a voltage to frequency converter). Gaussian phase noise may be applied in linear modulators (such as Project 25 (P25)/Astro phase II systems) directly in the baseband phase domain in the transmitter (e.g., at the baseband I and Q samples, by multiplying the baseband I and Q samples by a Gaussian random variable or adding a random Gaussian phase), which again is not readily possible in many frequency modulation systems such as digital mobile radio (DMR) systems. Any corrections or perturbations must be applied in the frequency domain to (real) symbol frequency sample values that drive frequency modulators (e.g., in DMR and/or land mobile radio (LMR) systems, and the like). The phase of the frequency modulated signal is generally represented by integrating the frequency domain (real) symbol frequency values in such cases.

Furthermore, some DMR and/or LMR radio receivers have been shown to be very sensitive to even small frequency offsets between simulcast signals in the field, especially rapidly changing frequency offsets that occur with such traditional dithering techniques (e.g., much higher than a frame rate), resulting in significant BER floors even for small frequency offsets (e.g., a few Hz).

Thus, there exists a need for an improved technical method, device, and system to reduce RF self-interference in simulcast radio systems Hence, provided herein is a device, system and method to reduce radio frequency self-interference in simulcast radio systems. In particular, methods for use with frequency modulators (e.g., used in DMR and LMR systems) are described.

In particular, a provided system includes at least two base stations, which are understood to be in communication, for example via a controller, such as a base station controller (BSC) or site/trunking controller, which may be incorporated into one or more of the base stations or external to the base stations (e.g., a central controller). A base station and/or the controller generates a first random variable according to a given distribution, such as a Gaussian distribution, and/or any other bell-shaped distribution, and/or a uniform/flat distribution, and the like. For example, the base station and/or the controller may have access to a random number generator that generates random numbers according to the given distribution (e.g., uniform or Gaussian). A peak and/or maximum of the given distribution may be at a center of the given distribution and/or such a given distribution may have no peaks. Using a Gaussian and/or bell-shaped distribution as a specific example, values of the given distribution may range between given outer values, such as between −1 and 1, with peak and/or maximum midway between the outer values, and/or at 0 (e.g., a mean value of zero). Similarly, a uniform distribution may vary between −1 and 1, with equally likely values, and a mean value of zero.

The base station and/or the controller maps the first random variable to a second variable determined using a bimodal distribution, which may be comprise a bimodal function and/or a quantized bimodal distribution of offset values (e.g., as piece-wise linear or non-linear functions), so that a distribution of second variables is also bimodal. For example, such a bimodal distribution is understood to include two peaks and/or two maxima, or two regions of non-zero values, for example on either side of a “0” position in the bimodal distribution (e.g., at positive and negative locations). In such a bimodal distribution, peaks and/or maxima of the given distribution may be biased towards the outer values of the distribution. For example, values of the bimodal distribution may range between given outer values, such as between −1 and 1, with peaks and/or maxima towards the outer values, or at −1 and 1, and mean value of zero.

Such a mapping may be quantized, such that values of the first random variable that are in certain ranges are mapped to discrete offset values used to determine the second variable. Furthermore, the mapping may be such that values of the first random variable are more likely to be mapped towards outer values of the bimodal distribution than values midway between the outer values. Put another way, and again using a −1 to 1 range for both the given distribution and the bimodal distribution, the mapping may be selected to ensure that values of the first random variable that are between −0.5 and 0.5 are respectively mapped towards values of the second variable that are between −1 to −0.5, and 0.5 to 1.

Once the second variable is determined, the base station uses the second variable to offset a given respective frequency of transmitted symbols. For example, for a given transmit frequency, a baseline offset frequency may be predetermined, and the baseline offset frequency may be multiplied by the second variable, and/or any other suitable scaling factors, to generate an offset frequency. The offset frequency may be added to the given respective frequency of transmitted symbols.

In a specific example, for a given respective radio frequency of 450 MHz (e.g., a carrier signal frequency), a scaled baseline offset frequency may be related to 1944 Hz (e.g., representing the outer frequency symbols of DMR modulation; for example, DMR modulation has a maximum symbol frequency (at baseband) of +/−1944 Hz). In this specific example, when the second variable is between −1 and 1, the offset frequency may be determined by multiplying the baseline offset frequency of 1944 Hz by the second variable, and applying an additional scaling factor of 0.5% (or 0.005), that may be heuristically determined. Alternatively, a scaling factor of 9.72 Hz may be used (e.g., 1944 Hz×0.5%), and the scaling factor may be multiplied by the second variable to determine the offset frequency. Again using values of the second variable that are between −1 and 1, in this example, the determined offset frequency may vary between −9.72 Hz and 9.72 Hz, and be generally weighted towards the outer values of this range. Other ranges or scaling factors may be utilized without any loss of generality.

Furthermore, it is understood that generating of the first random variable associated with the base station may be coordinated with generating of a respective first random variable associated with a further base station transmitting respective transmitted symbols that are a same as symbols transmitted by the base station. In particular, the first random variable of the base station and the respective first random variable of the second base station may result in different mappings to respective second random variables, and hence different respective determined offset values. Put another way, the different base stations of the simulcast system both use offset frequencies determined using the bimodal distribution, but the offset frequencies may be different at the different base stations.

An aspect of the present specification provides a method comprising: generating, at a base station or a controller, a first random variable according to a given distribution; mapping, at the base station or the controller, the first random variable to a second variable using a bimodal distribution of offset values; and using, at the base station, the second variable to offset a given respective frequency of transmitted symbols.

Another aspect of the present specification provides a computing device comprising: one or more of a base station and a controller; a communication interface; a processor; and a computer-readable storage medium having stored thereon program instructions that, when executed by the processor, causes the processor to perform a set of operations comprising: generating, at the base station or the controller, a first random variable according to a given distribution; mapping, at the base station or the controller, the first random variable to a second variable using a bimodal distribution of offset values; and using, at the base station, the second variable to offset a given respective frequency of transmitted symbols transmitted via the communication interface.

Another aspect of the present specification provides a system comprising: a base station; a controller; a communication interface; a processor; and a computer-readable storage medium having stored thereon program instructions that, when executed by the processor, causes the processor to perform a set of operations comprising: generating, at the base station or the controller, a first random variable according to a given distribution; mapping, at the base station or the controller, the first random variable to a second variable using a bimodal distribution of offset values; and using, at the base station, the second variable to offset a given respective frequency of transmitted symbols transmitted via the communication interface.

Each of the above-mentioned embodiments will be discussed in more detail below, starting with example system and device architectures of the system in which the embodiments may be practiced, followed by an illustration of processing blocks for achieving an improved technical method, device, and system to reduce radio frequency self-interference in simulcast radio systems.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Herein, the term “engine” is understood to refer to hardware, and/or a combination of hardware and software (e.g., a combination of hardware and software includes software hosted at hardware, such as a software module that is stored at a processor-readable memory implemented or interpreted by a processor), or hardware and software hosted at hardware and/or implemented as a system-on-chip architecture and the like.

Further advantages and features consistent with this disclosure will be set forth in the following detailed description, with reference to the drawings.

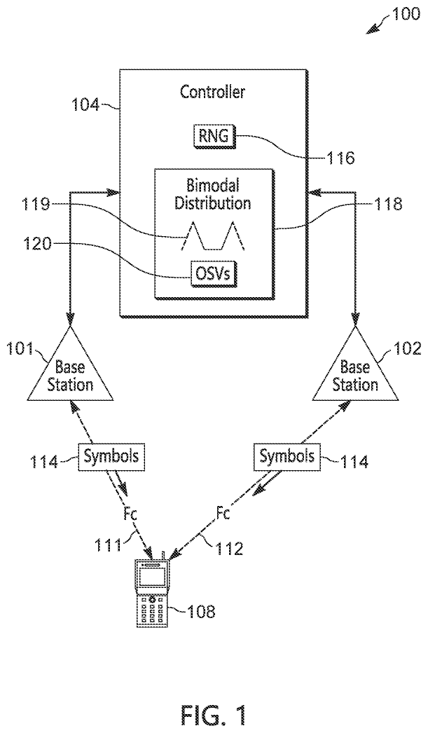

Attention is directed to FIG. 1, which depicts an example system 100 to reduce radio frequency self-interference in simulcast radio systems. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like, unless otherwise indicated. In particular, wireless links are depicted using broken lines.

The system 100 comprises two base stations 101, 102 in communication with a controller 104, which may comprise a base station controller integrated into one of the base stations 101, 102, or may (as depicted) comprise a central controller external to the base stations 101, 102. Regardless, the base stations 101, 102 are understood to be in communication and/or one or more of the base stations 101, 102 and/or the controller 104 may coordinate communications of the base stations 101, 102 as described herein. Herein the base stations 101, 102 may be referred to, respectively as a first base station 101 and a second base station 102, and/or the base stations 101, 102 may be referred to, respectively as the base station 101 and the further base station 102.

Furthermore, while only two base stations 101, 102 are depicted, the system 100 may comprise any suitable number of base stations, and techniques described herein may be implemented with respect to all such base stations, and/or a suitable subset thereof, that may participate in transmitting same symbols in a simulcast manner, for example to at least one communication device 108. Similarly, while only one communication device 108 is depicted, the system 100 may include any number of communication devices receiving same symbols in a simulcast manner from base stations of the system 100, and any number of talk groups or data streams (e.g., on different slots or channels, with different devices potentially receiving different simulcast symbol streams).

The base stations 101, 102 may comprise respective transceivers that are communication points of a wireless communication network to provide wireless communications for at least one communication device 108. While such a wireless network is not depicted, the wireless network is understood to be represented in FIG. 1 by respective wireless communication links 111, 112 (e.g., drawn in broken lines) respectively between the base stations 101, 102 and the communication device 108. In particular, as depicted, the wireless communication links 111, 112 are understood to transmit and receive data, such as symbols 114 transmitted by the base stations 101, 102, to the communication device 108, via a carrier frequency Fc. The carrier frequency Fc may depend on the type of wireless network implemented via the base stations 101, 102, but which may include, but is not limited to, wireless networks that operate according to a DMR (digital mobile radio) standard and/or LMR (land mobile radio) standard and/or a Time Division Multiple Access (TDMA) standard in any number of suitable frequency bands. In a particular example, the simulcast carrier frequency Fc may be in the 450 MHz Ultra-High Frequency (UHF) band with a channel bandwidth of 12.5 kHz, with the system 100 operating according to the DMR (2-slot) TDMA standard, such that the symbols 114 are transmitted in slots (e.g., of 30 ms in length, at a 4800 symbols/second rate) to the communication device 108.

The controller 104, when separate from a base station 101, 102, may comprise one or more servers and/or cloud computing devices, which may be remote from the base stations 101, 102, and in communication with the base stations 101, 102 via one or more wired and/or wireless networks different from the wireless network represented by the wireless communication links 111, 112, and which may include, but is not limited to, the Internet. Dedicated connections such as point-to-point microwave links, or wired connections such as T1 or multiprotocol label switching (MPLS) links may also be utilized, amongst other possibilities.

In particular examples, the communication device 108 may comprise a subscriber unit, a two way radio (as depicted), a mobile radio, a mobile phone-type device, and the like, that operates according the same standard as the base stations 101, 102 (e.g., such as TDMA).

It is understood that the system 100 generally comprises a simulcast system. For example, as depicted, the base stations 101, 102 are transmitting the same symbols 114 to the communication device 108 at the same time.

It is understood that the symbols 114 may include any suitable data encoded in any suitable manner, such as voice data, text, images, amongst other possibilities. For example, the symbols 114 may include data coded and/or converted to binary code, and specifically transmitted as pairs of zeros (“0s”) and ones (“1s”) that, when assembled by the communication device 108 may be decoded and/or converted into such data. Put another way, a symbol 114 may comprise a pair of a 0 and 1, in any suitable order, that may represent a portion of transmitted data.

For example, voice data from another communication device (not depicted) may be transmitted to the communication device 108 as the symbols 114 via both the base stations 101, 102, for redundancy, and at a same time. However as the paths of the wireless communication links 111, 112 are different, when respective signals carrying the symbols 114 are transmitted at a same frequency (e.g., the carrier frequency Fc), and transmitted at a same time (e.g., due to the simulcast nature of the system 100), the respective signals may arrive at the communication device 108 out of phase and hence may at least partially destructively interfere. Such interference may persist for long periods of time, causing significant signal and data loss.

Hence, as described herein, the base stations 101, 102 and/or the controller 104 are configured to generate a first variable, for example via a random number generator (RNG) 116 that, as depicted, is implemented at the controller 104, but that may be implemented at one or both of the base stations 101, 102. The RNG 116 is understood to generate random numbers according to a given distribution, including, but not limited to, a Gaussian distribution, a bell-shaped distribution, a uniform distribution, and the like. The term “distribution” as used herein may be interchangeably be referred to as a probability density function. Regardless, it is understood that the given distribution and/or the given probability density function may be either unbiased (e.g., uniform distribution), or biased towards a mid-point between outer values (e.g., a Gaussian distribution, a bell-shaped distribution and the like), such as between −1 and 1. This may be referred to as the mode of the probability density function. Probability density functions that have a single (or no) peak area are often termed to have a single mode, while other probability density functions may have two modes or peak areas (e.g., are bimodal).

Indeed, a range of −1 to 1 will be used hereafter, as this is a common range output by random number generators, though any suitable range is within the scope of the present specification. However, in the example, random numbers generated by the RNG 116 are understood to be between −1 and 1, and hence a first random variable generated by the RNG 116 is understood to be between −1 and 1. Furthermore, when the RNG 116 generates random numbers according to Gaussian and/or bell-shaped distribution, there is a higher probability that the random numbers will be closer to 0 (e.g., the midpoint between −1 and 1) then −1 or 1.

As depicted, the controller 104 (and/or one or both of the base stations 101, 102) may further store a bimodal distribution 118 that is represented by a graph 119 showing two peaks or regions of higher probability values. For example, the probability density function may peak at +/−0.75 (or any other suitable value, as illustrated by the graph 119), or may be flat and non-zero (indicating equally likely values) between −1 and −0.5, and between 0.5 to 1, with zeros or small values in between those two regions. Both distributions in this case are considered to be bimodal. Different ranges of the bimodal distributions are possible with no loss of generality.

In some example, the bimodal distribution 118 may include specific offset values (OSVs) 120. In a particular example, the offset values 120 of the bimodal distribution 118 may be predetermined, and may comprise the following values (again using a range between −1 and 1):

[−1, −0.94, −0.88, −0.82, −0.76, −0.57, 0, 0.57, 0.76, 0.82, 0.88, 0.94, 1]

Such a distribution of the offset values 120 is understood to be bimodal as there are peaks at between −1 to −0.57 and 0.57 to 1 (in two regions or areas), and a minima at 0 and/or between the two next values closest to zero of −0.57 and 0.57.

It is further understood that a first random variable generated by the RNG 116 may be mapped (e.g., by the controller 104 and/or one or more of the base stations 101, 102) to a second variable using the bimodal distribution 118 of the offset values 120. In particular, a first random variable generated (e.g., having a uniform probability density function) by the RNG 116 may be uniformly mapped to the second variable distribution above ([−1, −0.94, −0.88, −0.82, −0.76, −0.57, 0, 0.57, 0.76, 0.82, 0.88, 0.94, 1]).

Hereafter, with reference to the second variable distribution of offset values 120 of [−1, −0.94, −0.88, −0.82, −0.76, −0.57, 0, 0.57, 0.76, 0.82, 0.88, 0.94, 1], the first value of −1 will be referred to as the first offset value 120,], the second value of −0.94 will be referred to as the second offset value 120, etc.

For example, the first random variables may be quantized, or in this example, equally divided into N regions (e.g., an “N” number of levels of quantization), where N is equal to the number of values in the distribution of the second variable (e.g., N=13 in this example). In this scheme, for negative random first variables, when:
The first random variables generated by the RNG 116 that are between approximately-1 and −0.846, a first offset value 120 (e.g., from the offset values 120 above) is selected and mapped to a second variable value of −1.
The first random variables generated by the RNG 116 that are between approximately-0.846 and −0.692, the second offset value 120 is selected and mapped to a second variable value of −0.94.
The first random variables generated by the RNG 116 that are between approximately-0.692 and −0.538, the third offset value 120 is selected and mapped to a second variable value of −0.88.
The first random variables generated by the RNG 116 that are between approximately-0.538 and −0.385, the fourth offset value 120 is selected and mapped to a second variable value of −0.82-.
The first random variables generated by the RNG 116 that are between approximately-0.385 and −0.231, the fifth offset value 120 is selected and mapped to a second variable value of −0.76.
The first random variables generated by the RNG 116 that are between approximately-0.231 and −0.077, the sixth offset value 120 is selected and mapped to a second variable value of −0.57.
The first random variables generated by the RNG 116 that are between approximately-0.077 and 0.077, the seventh offset value 120 is selected and mapped to a second variable value of 0.

Similarly, for positive first random variable values, when:
The first random variables generated by the RNG 116 that are between approximately 0.077 and 0.231, the eighth offset value 120 is selected and mapped to a second variable value of 0.57.
The first random variables generated by the RNG 116 that are between approximately 0.231 and 0.385, the ninth offset value 120 is selected and mapped to a second variable value of 0.76.
The first random variables generated by the RNG 116 that are between approximately 0.385 and 0.538, the tenth offset value 120 is selected and mapped to a second variable value of 0.82.
The first random variables generated by the RNG 116 that are between approximately 0.538 and 0.692, the eleventh offset value 120 is selected and mapped to a second variable value of 0.88.
The first random variables generated by the RNG 116 that are between approximately 0.692 and 0.846, the twelfth offset value 120 is selected and mapped to a second variable value of 0.94.
First random variables generated by the RNG 116 that are between approximately 0.846 and 1, the thirteenth offset value 120 is selected and mapped to a second variable value of 1.

Hence, for first random variables generated according to a uniform-shaped distribution (e.g., or Gaussian distribution in some examples), the corresponding second variables are (e.g., always) “pushed” outwards to be higher (for positive first random variables) or lower (for negative first random variables). Note in some implementations that when N (the number of discrete frequency offset values of the second random variable) is a value corresponding to a power of two, the table of those values may be indirectly addressed by a signed digit representation of the first random variable, by taking the log₂ (N) most significant bits (MSBs) of a binary signed digit representation of the first random variable. Similarly, other mappings of the first random variable to the second variable of bimodally distributed frequency offset values may be utilized, with no loss of generality.

For example, if the first random variable had a Gaussian or Normal distribution, the techniques described above could be utilized (resulting in the smaller frequency offset values for the second variable being more likely), or the first distribution could be quantized, binned, or segmented differently (e.g., into equal probability bins, with bin thresholds determined by integration of the first random variable) when mapping it to the second variable. For example, if the first random variable were quantized or binned into values at values of (e.g., approximately)+/−[0.2, 0.41, 0.62, 0.87, 1.2, 1.78], the first random variable could be mapped to nearly equally likely frequency offset values of the second variable. In this case (and again using the above example offset values 120), when the value of the first random variable is between −0.2 and 0.2, the second variable would be equal to zero; when the value of the first random variable is between 0.2 and 0.41, the second random variable would be equal to 0.57; when the value of the first random variable is between −0.2 and −0.41, the second random variable would be equal to −0.57; when the value of the first random variable is between 0.41 and 0.62, the second random variable would be equal to 0.76; when the value of the first random variable is between −0.41 and −0.62, the second random variable would be equal to −0.76; and so on, in similar fashion. (Also note in this example, the sign of the first random variable would generally match the sign of the second variable.)

Approximations to the above mappings may also be utilized without any loss of generality. In addition, other mathematically based mappings or translations of the first random variable to the second variable may be utilized, such as piece-wise linear or non-linear functions, and the like. For example, the first random variable (over the range-1 to +1) could be divided by two, and then the absolute value of the first random variable (divided by two) may be added to 0.5, for example if the result of the division by two was positive, or subtracted from −0.5 if the result of the division by two was negative, to map it to the (−1 to −0.5) and the (0.5 to 1) ranges for the second variable. (In this manner, the second variable value becomes more continuous, and less discrete than the examples above.) However, the probability density function of the resulting second variable should remain approximately bimodal (e.g., having two distinct regions of more likely values), for example, with fewer smaller offset values (e.g., fewer of the offset values would be centrally located around zero), in order to quickly break up the destructive interference described above.

In some other examples, zero may be omitted from the offset values 120, and it is understood that when two offset values 120 having smallest absolute values are positive and negative, when a first random variable is between zero and a next highest absolute value determined offset value 120, the first random variable is to be mapped to the next highest absolute value determined offset value 120, and not zero, and that the corresponding second variable is the same sign (e.g., negative or positive) as the first random variable.

Similarly, in some examples, −1 and 1 may be omitted from the offset values 120, and it is understood that when a first random variable is higher than a highest absolute value determined offset value 120, the first random variable may be mapped to −1 or 1, depending on the sign (e.g., negative or positive) of the first random variable.

Once a second variable is determined, the second variable may be used, at a base station 101, 102, to offset a given respective frequency of transmitted symbols 114. The determination of an offset frequency may occur at the controller 104, and/or one or more of the base stations 101, 102. In many examples, this may occur at each of the base stations 101, 102 in the symbol mapping and modulation function.

In particular, for a determined second random variable, an offset frequency may be determined by: multiplying the second variable by a predetermined scaling factor to generate the offset frequency. The offset frequency may then be added to the given respective frequency.

Using the example of a carrier frequency of 450 MHZ, and a nominal scaling factor of 0.5%, as well as a baseline offset frequency of 1944 Hz (e.g., used to bring the nominal scaling factor into the frequency domain) a scaling factor of 9.72 Hz may be used (e.g., 1944 Hz×0.5%).

For example, multiplying each of the offset values 120 of [−1, −0.94, −0.88, −0.82, −0.76, −0.57, 0, 0.57, 0.76, 0.82, 0.88, 0.94, 1] by 9.72 Hz results in respective offset frequencies of:
[−9.72 Hz, −9.14 Hz, −8.55 Hz, −7.97 Hz, −7.39 Hz, −5.54 Hz, 0 Hz, 5.54 Hz, 7.39 Hz, 7.97 Hz, 8.55 Hz, 9.14 Hz, 9.72 Hz]

Indeed, in some examples, the first random variable may be mapped to such a set of (e.g., determined) offset frequencies; put another way, the second variables may correspond to offset values 120 that are in a frequency domain.

Hence, in one example, the value of a first random variable of −0.2 may be mapped to −0.57, which is in turn mapped to an offset frequency (e.g., a second variable in a frequency domain) of −5.54 Hz (e.g., as −0.2 is between −0.231 and −0.077 in the example above), which may be added to the carrier frequency Fc of 450 MHz by a base station 101, 102, when transmitting the symbols 114 (e.g., and/or the offset frequency may be added to the symbol frequency value prior to modulation onto the carrier frequency).

In another example, the value of a first random variable of 0.2 may be mapped to an offset frequency (e.g., a second variable in a frequency domain) of 5.54 Hz (e.g., as 0.2 is between 0.231 and −0.077 in the example above, which corresponds to 0.57), which may be added to the carrier frequency Fc of 450 MHz by a base station 101, 102, when transmitting the symbols 114.

Furthermore, it is understood that the first random variables and/or second variables used to determine the offset frequencies for the base stations 101, 102 may be coordinated, such that, for a given set of symbols, respective first random variables and/or respective second variables used to determine respective offset frequencies used by the base stations 101, 102 to transmit the same symbols 114, at the same time, are different.

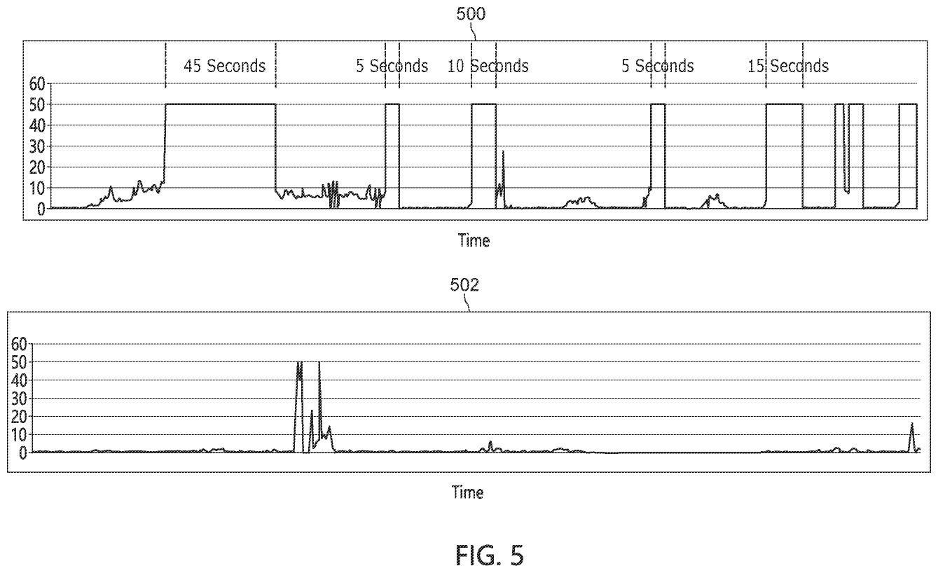

Indeed, it has been empirically shown through extensive field testing (e.g., see FIG. 5) that such a scheme results in overall reduction of BER and/or a reduction in lost signal packets and/or a reduction in lost voice and/or data packets and/or a reduction in sync loss, and the like. For example, the controller 104 may also determine different respective first random variables for the base stations 101, 102 for a given set of symbols 114 to be transmitted by both the base stations 101, 102 and consequently determine different respective second variables for the base stations 101, 102 and different respective offset frequencies for the base stations 101, 102. Alternatively, one or more of the base stations 101, 102 may perform such functionality.

Indeed, in some examples, different sets of offset values 120 (e.g., having bimodal distributions) may be associated with the base stations 101, 102 so that different respective second variables are always determined. However, in some example, a same set of offset values 120 may be used for the base stations 101, 102; while this example has a chance of the base stations 101, 102 using a same offset frequency, the base stations 101, 102 utilizing different offset frequencies is still more likely.

Indeed, the functionality of the system 100 may be distributed between one or more of the controller 104, and/or one or more of the base stations 101, 102, such that determining different respective offset frequencies for the base stations 101, 102 may occur at one or more one or more of the controller 104, and/or one or more of the base stations 101, 102, and the different respective offset frequencies may be communicated to the base stations 101, 102 by whichever component of the system 100 that may be determining the different respective offset frequencies.

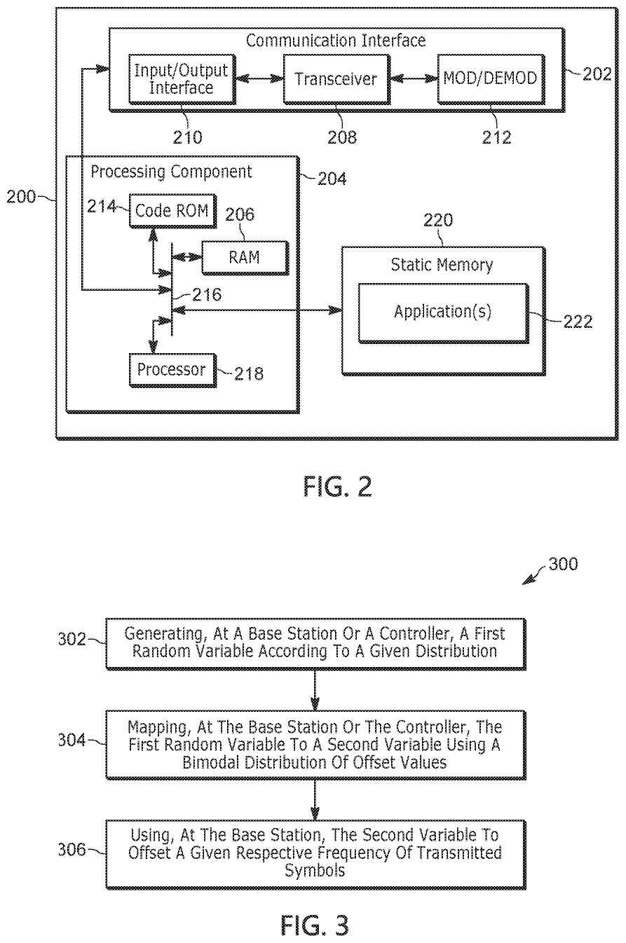

Attention is next directed to FIG. 2, which depicts a schematic block diagram of an example of a computing device 200 that implements functionality described herein. Indeed, the computing device 200 may be a component of one or more of the base stations 101, 102 and/or the controller 104. While the computing device 200 is depicted in FIG. 2 as a single component, functionality of the computing device 200 may be distributed among a plurality of components and the like including, but not limited to, any suitable combination of one or more servers, one or more cloud computing devices, on-premises processors (e.g., digital signal processors, micro-controllers, microprocessors, application specific processors, etc.), and the like (e.g., depending on whether the computing device 200 is implemented by the controller 104 and/or a base station 101, 102, and whether the controller 104 is integrated with, or separate from, a base station 101).

Indeed, the computing device 200 may be integrated with, and/or may comprise, a base station controller of one or more of base stations 101, 102. In some examples, the computing device 200 may be a component of a network management system or trunking controller, and the like, and the computing device 200 may control operations of a plurality of base stations, including, but not limited to, the base stations 101, 102. One specific example of a network management system (or trunking controller) is the Capacity Max™ System Server (CMSS) function that is utilized in Motorola Solutions Inc.™ DMR trunking radio solutions.

As depicted, the computing device 200 comprises: a communication interface 202, a processing unit 204, a Random-Access Memory (RAM) 206, one or more wireless transceivers 208, one or more wired and/or wireless input/output (I/O) interfaces 210, a combined modulator/demodulator 212, a code Read Only Memory (ROM) 214, a common data and address bus 216, a processor 218, and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the computing device 200 may have any suitable structure and/or configuration.

While not depicted, the computing device 200 may include, and/or be in communication with, one or more of an input component and a display screen (and/or any other suitable notification device) and the like.

As shown in FIG. 2, the computing device 200 includes the communication interface 202 communicatively coupled to the common data and address bus 216 of the processing unit 204.

The processing unit 204 may include the code Read Only Memory (ROM) 214 coupled to the common data and address bus 216 for storing data for initializing system components. The processing unit 204 may further include the processor 218 coupled, by the common data and address bus 216, to the Random-Access Memory 206 and the static memory 220.

The communication interface 202 may include one or more wired and/or wireless input/output (I/O) interfaces 210 that are configurable to communicate with other components of the system 100. For example, the communication interface 202 may include one or more wired and/or wireless transceivers 208 for communicating with other suitable components of the system 100. Hence, the one or more transceivers 208 may be adapted for communication with one or more communication links and/or communication networks used to communicate with the other components of the system 100.

However, it is understood that the communication interface 202 may depend on where the computing device 200 is implemented. For example, when the computing device 200 is a component of the controller 104 and comprises a cloud computing device, the communication interface 202 may be configured to communicate with the base stations 101, 102 via the Internet and/or any other suitable a wired network (e.g., an IEEE 802.3 network), though communications between the computing device 200 and other components of the system 100 (e.g., the controller 104 and the base stations 101, 102) may occur using any suitable combination of wired and/or wireless networks.

When the computing device 200 is at least partially implemented by a base station 101, 102, the communication interface 202 may be configured to communicate with the communication device 108 via any suitable wireless network, including, but not limited to, one or more of a DMR network, an LMR network a Project 25 (P25) network, a terrestrial trunked radio (TETRA) network, a microwave network, and the like and/or a network generally operating utilizing TDMA, CDMA (code-division multiple access) or OFDM (orthogonal frequency division multiplexing) modulations.

Alternatively, or in addition the communication interface 202 may be configured to communicate with the communication device 108 via one or more of a 3GPP (3rd Generation Partnership Project) 4G LTE (Long-Term Evolution) network, a 3GPP 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or other types of GSM (Global System for Mobile communications) and/or another similar type of wireless networks.

Alternatively, or in addition the communication interface 202 may be configured to communicate via a Bluetooth network, a Wi-Fi network, for example operating in accordance with an IEEE 802.11 standards (e.g., 802.11a, 802.11b, 802.11g), and the like.

Hence, the one or more transceivers 208 may include, but are not limited to, a cell phone transceiver, a wired network (e.g., an IEEE 802.3 network) transceiver, a DMR transceiver, P25 transceiver, a TETRA transceiver, an LMR transceiver, a TDMA receiver, a 3GPP transceiver, a 4G LTE transceiver, a GSM transceiver, a 5G NR (new radio) transceiver, a Bluetooth transceiver, a Wi-Fi transceiver, a WiMAX transceiver, and/or another similar type of wireless transceiver configurable to communicate via a wireless radio network.

The communication interface 202 may further include one or more other wireline transceivers 208, such as a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The processor 218 may include ports (e.g., hardware ports) for coupling to other suitable hardware components of the system 100.

The processor 218 may include one or more logic circuits, one or more processors, one or more microprocessors, one or more GPUs (Graphics Processing Units), and/or the processor 218 may include one or more ASIC (application-specific integrated circuits) and one or more FPGA (field-programmable gate arrays), and/or another electronic device. In some examples, the processor 218 may more specifically comprise a digital signal processor (DSP), which may be suitable for transmitting symbols 114 at different frequencies as described herein.

In some examples, the processor 218 and/or the computing device 200 is not a generic controller and/or a generic device, but a device specifically configured to implement functionality to reduce radio frequency self-interference in simulcast radio systems. For example, in some examples, the computing device 200 and/or the processor 218 specifically comprises a computer executable engine configured to implement functionality to reduce radio frequency self-interference in simulcast radio systems.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the computing device 200 as described herein are maintained, persistently, at the memory 220 and used by the processor 218, which makes appropriate utilization of volatile storage during the execution of such programming instructions.

Regardless, it is understood that the memory 220 stores instructions corresponding to the at least one application 222 that, when executed by the processor 218, enables the processor 218 to implement functionality to reduce radio frequency self-interference in simulcast radio systems, including, but not limited to, the blocks of the method set forth in FIG. 3.

Put another way, the memory 220 may comprise a (e.g., non-transitory) computer-readable storage medium having stored thereon program instructions that, when executed by the processor 218, causes the processor 218 to perform a set of operations comprising the blocks of the method set forth in FIG. 3.

While details of the communication device 108 is not depicted, the communication device 108 may have components similar to the computing device 200 adapted, however, for the functionality thereof, for example for receiving and decoding the symbols 114 via the wireless communication links 111, 112.

Attention is now directed to FIG. 3, which depicts a flowchart representative of a method 300 to reduce radio frequency self-interference in simulcast radio systems. The operations of the method 300 of FIG. 3 correspond to machine readable instructions that are executed by the controller 104, and specifically the processor 218 of the computing device 200. In the illustrated example, the instructions represented by the blocks of FIG. 3 are stored at the memory 220 for example, as the application 222. The method 300 of FIG. 3 is one way that the processor 218 and/or the of the computing device 200 and/or the base stations 101, 102 and/or the controller 104 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

Furthermore, while the method 300 is described with respect to the base station 101, 102 the method 300 may be implemented with respect to a plurality of base stations including, but not limited to, the base stations 101, 102. For example, the computing device 200 may be implementing the method 300 to control operation of the base stations 101, 102, as well as to control operation of other base stations.

At a block 302, the processor 218, and/or the computing device 200 (e.g., a base station 101, 102 and/or the controller 104), generates a first random variable according to a given distribution.

For example, the RNG 116 may be used to generate the first random variable.

Furthermore, the given distribution of the first random variable may comprise one of a uniform distribution, a Gaussian distribution, and a bell-shaped distribution, amongst other possibilities.

At a block 304, the processor 218, and/or the computing device 200 (e.g., a base station 101, 102 and/or the controller 104), maps the first random variable to a second variable determined using the bimodal distribution 118 of the offset values 120.

At a block 306, the processor 218, and/or the computing device 200 (e.g., more specifically a base station 101, 102), uses the second variable to offset a given respective frequency (e.g., the transmitted carrier frequency) of transmitted symbols 114 (e.g., transmitted via the communication interface 202).

More specifically, at least offsetting of the given respective frequency of the transmitted symbols 114 may occur using one or more of a digital signal processor (e.g., the processor 218) and a modulator (e.g., the modulator 212) of a base station 101, 102.

Further features of the method 300 is next described.

For example, the offset values 120 may comprise, and/or be limited to, a given number of given offset values, and the mapping (e.g., of the block 304) of the first random variable to the second variable may comprise: quantizing the first random variable to the given number of the given offset values; and selecting a respective value of the second variable from the given number of given offset values using the first random variable as quantized (e.g., to use a quantized first variable to using the quantized values to select and/or or look up one of the given number of given offset values). Put another way, the mapping of the first random variable to the second variable may be quantized, with the number of levels of quantization of the first random variable depending on the number of the offset values.

However, the mapping may occur in any suitable manner. For example, as previously described, the offset values 120 may comprises a limited number of given offset values, and the second random variable may comprise a uniformly selected predetermined offset value 120 based on the quantized values of the first random variable (as described above). However, any suitable mapping function may be used to map the first random variable to the second variable based on the bimodal distribution 118 of the offset values 120. For example, mathematical functions may be utilized to map the first random variable to the second variable (as described above), resulting in more continuous (e.g., many valued and/or non-quantized) sets of frequency offset values.

Furthermore, while a particular set of offset values 120 has been described in an example, any suitable set of offset values 120 is within the scope of the present specification. For example, the offset values 120 may comprise as few as four offset values 120 (e.g., [−0.997, −0.631, 0.631, 0.997]) that may be used to map the first random variable to the second variable, which is also an example of another bimodal distribution 118 of offset values 120. In this example (e.g., [−0.997, −0.631, 0.631, 0.997]) is understood that “−1”, “0” and “1” are omitted, but which may nonetheless be present.

In general, as the number of offset values 120 are increased, it is less likely that differing base stations choose (exactly) the same frequency offset, when choosing values in a random, uncoordinated fashion. Hence, frequency offsets for both the base stations 101, 102 may be generated using the same bimodal distribution of offset values.

In systems where the controller 104 is explicitly configured to avoid a same frequency offset being determined for two or more base stations 101, 102, the number of offset values 120 is less important. Put another way, in examples where different sets of offset values 120 (e.g., having bimodal distributions) are associated with the base stations 101, 102, any suitable respective number of respective offset values 120 may be used. However, in examples a same set of offset values 120 (e.g., having a bimodal distribution) are associated with the base stations 101, 102, a number of the offset values 120 may be at least a given number of offset values, that may be empirically determined. For example, the given number of offset values may be at least 4 in some examples, at least 10 in other examples, and at least 13 in yet further examples, though the given number may be any suitable number, and which may vary depending on locations of the base stations 101, 102 and/or environments in which the base stations 101, 102 are deployed (e.g., such factors may increase or decrease a likelihood of self-interference, and as the likelihood of self-interference increases, the given number may increase, and as the likelihood of self-interference decreases, the given number may decrease).

In some examples, the controller 104 may also attempt to avoid instances where the frequency offsets are similar (e.g., 9.4 Hz and 8.9 Hz) and/or within a given frequency of each other (e.g., the controller 104 may discard results that cause frequency offsets for different base stations 101, 102 to be within a given frequency range, such as 5 Hz, 6 Hz, 7 Hz, amongst other possibilities).

In some examples, the mapping of the first random variable to the second variable (e.g., at the block 304) may comprise: applying a mathematical function to the first random variable to compute the second variable. For example, such a mathematical function may include, but is not limited to, a piece-wise linear function or a non-linear function.

In some examples, the mapping (e.g., of the block 304) of the first random variable to the second variable (and/or the generating (e.g., of the block 302) of the first random variable) may occur at a predetermined rate such that frequency offsets to the given respective frequency of the transmitted symbols may occur at the predetermined rate.

For example, a base station 101, 102 may generally operate according to TDMA, and the mapping (e.g., of the block 304) of the second variable (and/or the generating (e.g., of the block 302) of the first random variable) may be at a predetermined rate related to a given TDMA slot rate (e.g., such as every 30 ms or 16.66 times per second for one slot of a two-slot TDMA system with two slots per frame). In particular, generation of a new first random variable may occur at a given TDMA slot rate (e.g., 16.66 times per second) so that the frequency offsets change at the given TDMA slot rate (e.g., 16.66 times per second). Furthermore, the same frequency offset may be applied to both slots in a DMR frame, or different frequency offsets may be applied to different slots in a DMR frame.

However, any suitable rate is within the scope of the present specification. For example, the system 100 may operate according to any suitable standard that may or may not use slots to transmit data. Hence, the predetermined rate at which the mapping (e.g., of the block 304) may occur may be according to a slot rate, a symbol transmission rate, a multiple of the symbol transmission rate, or another suitable predetermined rate, amongst other possibilities. In general, utilization of a slower predetermined rate (e.g., a slot rate or slower) allows (e.g., and/or often allows) the corresponding receiving communications devices 108 to better adapt to the frequency offset value (as opposed to applying a rapidly changing frequency offset value). This characteristic however, may be receiver dependent.

Furthermore, the RNG 116 may generate the first random variable at a rate faster than a predetermined rate at which the mapping (e.g., of the block 304) occurs, but the mapping may occur at the predetermined rate, with a portion of the first random variables not mapped being discarded.

As has been explained, the method 300 is may be implemented with respect to both base stations 101, 102 in a coordinated manner, such that the base stations 101, 102 transmit the same symbols 114 at a same time, but with different (and/or dissimilar) frequency offsets at each base station 101, 102.

Put another way, and using the first base station 101 as a reference base station, the method 300 may further comprise, the processor 218, and/or the computing device 200: coordinating the generating of the first random variable at the base station 101 with generating of a respective first random variable at the further base station 102 that is transmitting respective transmitted symbols 114 that are same as the transmitted symbols 114 transmitted by the base station 101, the base station 101 and the further base station 102 forming a simulcast system. In these examples, as the first random variable associated with the base station 101 and the respective first random variable associated with the further base station 102 are different, such that the first random variable associated with the base station 101 and the respective first random variable associated with the further base station 102 result in different respective offset values 120 of the offset values 120, and hence different offset frequencies used by the base stations 101, 102.

In particular, and again using the first base station 101 as a reference base station, the method 300 may further comprise, the processor 218, and/or the computing device 200: coordinating the mapping of the first random variable associated with the first base station 101 with a mapping of a respective first random variable associated with a further base station 102 transmitting respective one or more transmitted symbols 114 that are same as the transmitted symbols 114 transmitted by the first base station 101, the base station 101 and the further base station 102 forming a simulcast system. In these examples, the mapping of the first random variable associated with the first base station 101 to the second variable, and the mapping of the respective first random variable to a respective second variable result in different offset values 120 of the offset values 120, and hence different offset frequencies used by the base stations 101, 102.

In some examples, the method 300 may further comprise, the processor 218, and/or the computing device 200: offsetting the given respective frequency by: multiplying the second variable by a predetermined scaling factor to generate an offset frequency; and adding the offset frequency to the given respective symbol frequency.

However, any suitable process for determining the offset frequency from the first random variable mapped to a second variable using the bimodal distribution 118 of the offset values 120 is within the scope of the present specification.

As has been previously described, the second variable may be used to generate an offset frequency that is effectively added to the given respective frequency (e.g., the carrier frequency Fc). Using the example where a largest absolute value offset frequency is-9.72 Hz or 9.72 Hz, and the carrier frequency Fc is 450 MHz, in some examples, a frequency at which symbols 114 are transmitted may be limited to be within certain values to prevent numerical overflow (e.g., which would cause larger positive values to “wrap around” to large negative values, and vise-versa, when using a twos-complement binary number representation, for example). For example, a frequency at which symbols 114 are transmitted may be limited to be between 450 MHz+/−1944 Hz (representing the nominal outer or maximum transmitted frequencies, symbols, or frequency constellation points). In these examples, when a frequency offset is determined to be greater than an absolute value of 1944 Hz, the transmitted frequency or symbol value may first be scaled down by an amount (e.g., by 0.995, or 99.5% of the original value) that allows the frequency offset (e.g., of +/−9.72 Hz) to be applied without exceeding the 450 MHz+/−1944 Hz numerical limit (of the binary number representation system). For example, when an offset frequency of 9.72 Hz is determined, the transmitted carrier frequency may also be reduced by 9.72 Hz. This additional scaling value may be applied all of the time, or selectively, depending on the implementation (e.g., the additional scaling may be implemented in examples where numerical overflow is empirically determined to be a risk). In general, it is important that the transmitter not exceed its prescribed transmit spectral mask (which is often determined by the frequency band regulators, such as the Federal Communications Commission in the United States).

In such examples, the method 300 may further comprise the processor 218 and/or the computing device 200: when the given respective frequency of the transmitted symbols 114 has a largest absolute value amongst respective frequencies (e.g., 450 MHz+/−1944 Hz), reducing an absolute value of the given respective frequency prior to adding the offset frequency to the given respective frequency, such that the offset frequency added to the given respective frequency remains within or at given boundaries (e.g., 450 MHz+/−1944 Hz, and the like).

In some examples, the offset values 120 may comprise a zero mean offset sequence, such that a sum of all the offset values 120 adds to zero. For example, the offset values 120 of [−1, −0.94, −0.88, −0.82, −0.76, −0.57, 0, 0.57, 0.76, 0.82, 0.88, 0.94, 1] sums to zero. As the first random variables are randomly generated, such a scheme prevents bias in one direction or another for the offset frequencies (e.g., that could potentially drive frequency offset tracking algorithms in the receiver off in one direction or the other over time). However, in some examples (e.g., where frequency offsets at which symbols are transmitted are limited by boundaries that are not symmetric, such as +9.5 Hz and −9 Hz), such a bias may be introduced by using an offset values 120 that sum to a positive value or a negative value.

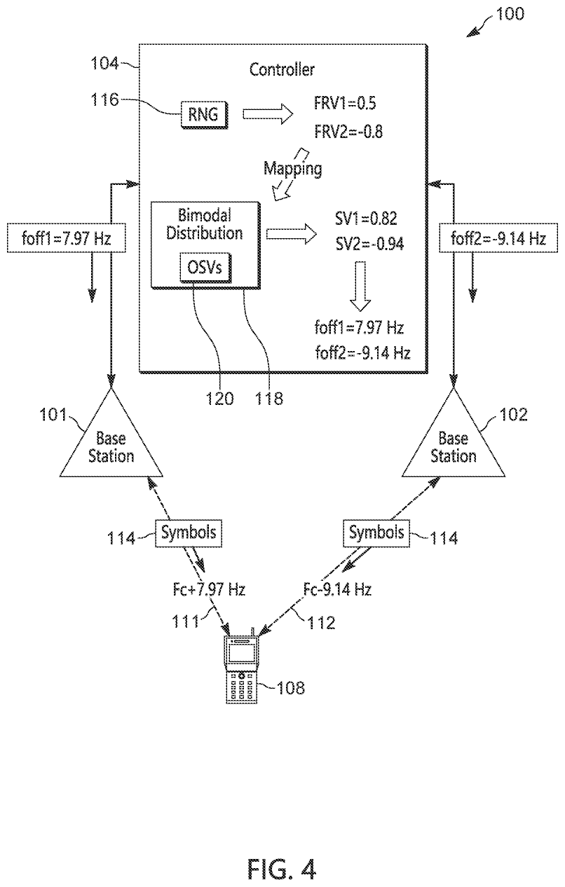

Aspects of the method 300 will next be described with respect to FIG. 4, which is substantially similar to FIG. 1, with like components having like numbers.

At FIG. 4, the RNG 116 at the controller 104 generates (e.g., at the block 302 of the method 300) two first random variables (e.g., random numbers, FRV1 and FRV2), of FRV1=0.5, and FRV2=−0.8. It is understood that the two first random variables FRV1, FRV2 may be generated sequentially. Alternatively, the system 100 may comprise two RNGs 116, generating random numbers concurrently or in parallel. The controller 104 may compare the two first random variables FRV1, FRV2 to ensure they are not the same. If they are the same, one may be discarded and a different first random variable generated by the RNG 116 may be selected, or any other suitable method may be utilized to ensure that the values of two first random variables FRV1, FRV2 are different.

The controller 104 maps (e.g., at the block 304 of the method 300, and as indicated by the term “MAPPING” in FIG. 4) the first random variables FRV1, FRV2 to respective second variables SV1, SV2. Such a mapping may occur sequentially or concurrently.

For example, using the offset values 120 of [−1, −0.94, −0.88, −0.82, −0.76, −0.57, 0, 0.57, 0.76, 0.82, 0.88, 0.94, 1], as the first random variable FRV1=0.5, a corresponding second variable SV1=0.82 (e.g., as FRV1=0.5 is between 0.385 and 0.538 in the example above).

Similarly, as the first random variable FRV2=−0.8, a corresponding second variable SV2=−0.94 (e.g., as FRV2=−0.8 is between −0.846 and −0.692 in the example above).

From the second variable SV1=0.82 and SV2=−0.94, corresponding offset frequencies foff1=7.97 Hz and foff2=−9.14 Hz may be determined (e.g., by multiplying each of SV1=0.82 and SV2=−0.94 by 1944 Hz×0.5%).

As depicted, the first offset frequency foff1=7.97 Hz is provided to the first base station 101, and the second offset frequency foff2=−9.14 Hz is provided to the second base station 102. Then, at a same time (e.g., a same slot in a TDMA network), for same symbols 114, the first base station 101 broadcasts the symbols 114 at the carrier frequency Fc with the first offset frequency foff1=7.97 Hz added thereto, and the second base station 102 broadcasts the same symbols 114 at the carrier frequency Fc with the second offset frequency foff2=−9.14 Hz added thereto (e.g., thereby using at the base stations 101, 102, the second variable SV1, SV2 to offset a given respective frequency of transmitted symbols 114, at the block 306 of the method 300).

As previously mentioned, the advantages of using the method 300 generally improves BER and sync loss in the simulcast system 100, as compared to when the method 300 is not used. In particular, the mapping of the first random variable to a second random variable using the bimodal distribution 118 of offset values 120 may increase a rate of differential (e.g., relative) phase change between the simulcast signals at the communication device 108 receiving same symbols 114 from the two or more base stations 101, 102. Put another way, by biasing the offset frequencies (for example by different values or in different directions) for two or more base stations 101, 102 using a bimodal distribution, the rate of differential phase change between arriving signals at the communication device 108 may increase, which helps to effectively break-up or counter destructive self-interference of symbols 114 received at the communication device 108 from the two or more base stations 101 and 102. In general, the more frequency offset between two or more arriving signals, the faster the destructive self-interference conditions can be avoided (due to the phase changes between signals).

For example, attention is next directed to FIG. 5, which depicts graphs 500, 502 showing measurements of BER as a function of time at the communication device 108 for when, respectively, the method 300 is not implemented (e.g., the graph 500) and the method 300 is implemented (e.g., the graph 502). Comparing the graph 500, 502, it is apparent that the average BER for the graph 500 is much higher than for the graph 502. Furthermore, the graph 500 indicates long period of times of sync loss (e.g., the flat regions of the graph 500 where the BER is around 50% resulting in complete signal loss, with the number of seconds of sync or signal loss indicated on the graph). The method 300 greatly reduces the occurrence of both high BER events and sync loss events. It is hence apparent that the method 300 has improved the technical operation and reliability of the system 100.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, offset frequencies of base stations, and the like).

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
generating, at a base station or a controller, a first random variable according to a given distribution;
mapping, at the base station or the controller, the first random variable to a second variable using a bimodal distribution of offset values; and
using, at the base station, the second variable to offset a given respective frequency of transmitted symbols.

2. The method of claim 1, wherein the offset values comprise a given number of given offset values, and wherein the mapping of the first random variable to the second variable comprises:
quantizing the first random variable to the given number of the given offset values; and
selecting a respective value of the second variable from the given number of given offset values using the first random variable as quantized.

3. The method of claim 1, wherein the mapping of the first random variable to the second variable comprises:
applying a mathematical function to the first random variable to compute the second variable.

4. The method of claim 1, wherein the mapping of the first random variable occurs at a predetermined rate such that frequency offsets to the given respective frequency of the transmitted symbols occur at the predetermined rate.

5. The method of claim 1, wherein the base station operates according to time division multiple access (TDMA), and the mapping of the second variable occurs at a predetermined rate related to a given TDMA slot rate.

6. The method of claim 1, further comprising:
coordinating the generating of the first random variable with generating of a respective first random variable at a further base station that is transmitting respective transmitted symbols that are same as the transmitted symbols, the base station and the further base station forming a simulcast system, wherein the first random variable and the respective first random variable result in different respective offset values, of the offset values, for the base station and the further base station.

7. The method of claim 1, further comprising:
coordinating the mapping of the first random variable with a mapping of a respective first random variable at a further base station transmitting respective one or more transmitted symbols that are a same as the transmitted symbols, the base station and the further base station forming a simulcast system, wherein respective mappings of respective first random variables to respective second random variables for the base station and the further base station result in different respective offset values, of the offset values, for the base station and the further base station.

8. The method of claim 1, further comprising offsetting the given respective frequency by:
multiplying the second variable by a predetermined scaling factor to generate an offset frequency; and
adding the offset frequency to the given respective frequency.

9. The method of claim 1, wherein the second variable is used to generate an offset frequency added to the given respective frequency of the transmitted symbols, the method further comprising:
when the given respective frequency has a largest absolute value amongst respective frequencies, reducing an absolute value of the given respective frequency prior to adding the offset frequency to the given respective frequency, such that the offset frequency added to the given respective frequency remains within or at given boundaries.

10. The method of claim 1, wherein the offset values comprises a zero mean offset sequence, such that a sum of all of the offset values adds to zero.

11. The method of claim 1, wherein the given distribution of the first random variable comprises one of a uniform distribution, a Gaussian distribution, and a bell-shaped distribution.

12. The method of claim 1, wherein at least offsetting of the given respective frequency of the transmitted symbols occurs using one or more of a digital signal processor and a modulator of the base station.

13. A computing device comprising:
one or more of a base station and a controller;
a communication interface;
a processor; and
a computer-readable storage medium having stored thereon program instructions that, when executed by the processor, causes the processor to perform a set of operations comprising:
generating, at the base station or the controller, a first random variable according to a given distribution;
mapping, at the base station or the controller, the first random variable to a second variable using a bimodal distribution of offset values; and
using, at the base station, the second variable to offset a given respective frequency of transmitted symbols transmitted via the communication interface.

14. The computing device of claim 13, wherein the offset values comprise a given number of given offset values, and wherein the mapping of the first random variable to the second variable comprises:
quantizing the first random variable to the given number of the given offset values; and
selecting a respective value of the second variable from the given number of given offset values using the first random variable as quantized.

15. The computing device of claim 13, wherein the mapping of the first random variable to the second variable comprises:
applying a mathematical function to the first random variable to compute the second variable.

16. The computing device of claim 13, wherein the mapping of the first random variable occurs at a predetermined rate such that frequency offsets to the given respective frequency of the transmitted symbols occur at the predetermined rate.

17. The computing device of claim 13, wherein the base station operates according to time division multiple access (TDMA), and the mapping of the second variable occurs at a predetermined rate related to a given TDMA slot rate.

18. The computing device of claim 13, wherein the set of operations further comprises:
coordinating the generating of the first random variable with generating of a respective first random variable at a further base station that is transmitting respective transmitted symbols that are same as the transmitted symbols, the base station and the further base station forming a simulcast system, wherein the first random variable and the respective first random variable result in different respective offset values, of the offset values, for the base station and the further base station.

19. The computing device of claim 13, wherein the set of operations further comprises:
coordinating the mapping of the first random variable with a mapping of a respective first random variable at a further base station transmitting respective one or more transmitted symbols that are a same as the transmitted symbols, the base station and the further base station forming a simulcast system, wherein respective mappings of respective first random variables to respective second random variables for the base station and the further base station result in different respective offset values, of the offset values, for the base station and the further base station.

20. The computing device of claim 13, further comprising offsetting the given respective frequency by:
multiplying the second variable by a predetermined scaling factor to generate an offset frequency; and
adding the offset frequency to the given respective frequency.
